(19) United States
(12) Patent Application Publication
(10) Pub. No.: US 2021/0383441 A1
(43) Pub. Date: Dec. 9, 2021

(54) SERVICE PROVIDING APPARATUS

(71) Applicant: Honda Motor Co., Ltd., Tokyo (JP)

(72) Inventors: Atsushi Ito, Wako-shi, Saitama (JP); Nanami Tsukamoto, Wako-shi, Saitama (JP); Shinichiro Yamauchi, Wako-shi, Saitama (JP); Tomoko Shintani, Wako-shi, Saitama (JP); Tetsuya Yashiki, Wako-shi, Saitama (JP); Takashi Tetsuka, Wako-shi, Saitama (JP)

(21) Appl. No.: 17/286,023

(22) PCT Filed: Sep. 27, 2019
(86) PCT No.: PCT/JP2019/038317

§ 371 Date: Apr. 16, 2021

(30) Foreign Application Priority Data
Oct. 22, 2018 (JP) 2018-198718

(51) Int. Cl. G06Q 30/02; G06Q 30/00; G06F 16/9535; G06F 16/9537; G06F 16/9538

(52) U.S. Cl. CPC G06Q 30/0282; G06Q 30/018; G06F 16/9538; G06F 16/9537; G06F 16/9535

(57) ABSTRACT

A service-providing-apparatus includes: profile-information-storage-unit storing profile-information including information representing personality of each of service-providers and user; service-information-storage-unit storing information about the service provided by the service-providers; request-information-acquisition-unit acquiring request-information about service requested by the user; candidate-extraction-unit extracting candidate who can provide the service requested by the user to the user based on the request-information; profile-comparison-unit comparing the profile-information about the candidate and the user; provider-determination-unit determining service-provider who provides the service requested by the user to the user based on comparison-result; and user-information-acquisition-unit acquiring user-information of each of the service-providers and the user transmitted from user-device of each of the service-providers and the user and storing the user-information acquired in the profile-information-storage-unit as the profile-information. The user-information-acquisition-unit acquires the user-information of each of the service-providers and the user based on use-state of the user-device of each of the service-providers and the user.

### CROSS-REFERENCE TO RELATED APPLICATION

This application is a National Stage of PCT international application Ser. No. PCT/JP2019/038317 filed on Sep. 27, 2019 which designates the United States, incorporated herein by reference, and which is based upon and claims the benefit of priority from Japanese Patent Application No. 2018-198718, filed on Oct. 22, 2018, the entire contents of which are incorporated herein by reference.

### TECHNICAL FIELD

This invention relates to a service providing apparatus configured to provide a service to a user who requests the service.

### BACKGROUND ART

There has been typically known an apparatus for presenting a user who requests a service with personal information, such as a face photograph and a hometown, of a plurality of service providers capable of providing the service, (for example, see Patent Literature 1). In the apparatus described in Patent Literature 1, when a user requests creation of a brochure or a web site, personal information of a creator, such as a face photograph, a hometown, and a creation image is presented to the user, so that the user can select the creator having the same sensitivity.

### CITATION LIST

### Patent Literature

Patent Document 1: Japanese Unexamined Patent Publication No. 2002-41837

### DISCLOSURE OF INVENTION

### Problems to be Solved by the Invention

In the apparatus described in Patent Literature 1, however, the user himself or herself has to refer to the personal information of the plurality of creators to select a creator from them. This is a complicated work.

### Means for Solving Problem

An aspect of the present invention is a service providing apparatus includes: a profile information storage unit configured to store a plurality of profile information including information representing personality of each of a plurality of service provider providing service and a user; a service information storage unit configured to store information about the plurality of service provider and the service provided by the plurality of service provider; a request information acquisition unit configured to acquire request information about a service requested by the user; a candidate extraction unit configured to extract a candidate who can provide the service requested by the user to the user from among the plurality of service provider stored in the service information storage unit based on the request information acquired by the request information acquisition unit; a profile comparison unit configured to compare the plurality of profile information about the candidate extracted by the candidate extraction unit and the user stored in the profile information storage unit; a provider determination unit configured to determine a service provider who provides the service requested by the user to the user based on a comparison result by the profile comparison unit; and a user information acquisition unit configured to acquire user information of each of the plurality of service provider and the user transmitted from a user device of each of the plurality of service provider and the user and configured to store the user information acquired in the profile information storage unit as the plurality of profile information. The user information acquisition unit acquires the user information of each of the plurality of service provider and the user based on a use state of the user device of each of the plurality of service provider and the user.

Another aspect of the present invention is a service providing apparatus includes: a profile information storage unit configured to store a plurality of profile information including information representing personality of each of a plurality of service provider providing service and a user; a service information storage unit configured to store information about the plurality of service provider and the service provided by the plurality of service provider; a request information acquisition unit configured to acquire request information about a service requested by the user; a candidate extraction unit configured to extract a candidate who can provide the service requested by the user to the user from among the plurality of service provider stored in the service information storage unit based on the request information acquired by the request information acquisition unit; a profile comparison unit configured to compare the plurality of profile information about the candidate extracted by the candidate extraction unit and the user stored in the profile information storage unit; a provider determination unit configured to determine a service provider who provides the service requested by the user to the user based on a comparison result by the profile comparison unit; and a user information acquisition unit configured to acquire user information of each of the plurality of service provider and the user transmitted from a user device of each of the plurality of service provider and the user and configured to store the user information acquired in the profile information storage unit as the plurality of profile information. The profile comparison unit sets weighting for parameters constituting personality of each of the plurality of service provider and the user based on the request information acquired by the request information acquisition unit and calculates similarity degree between personality of the candidate extracted by the candidate extraction unit and personality of the user for each of the parameters based on the plurality of profile information stored in the profile information storage unit.

### Effect of the Invention

According to the present invention, it becomes possible to automatically determine a service provider having the same sense of values with a user who requests the service.

### BRIEF DESCRIPTION OF DRAWINGS

FIG. 1 is a diagram schematically showing an application example of a service providing apparatus according to an embodiment of the present invention.

FIG. 2 is a block diagram schematically showing a configuration of the service providing apparatus according to the embodiment of the present invention.

FIG. 3A is a diagram for describing an example of information representing personality of a user that has been digitized by a user information acquisition unit in FIG. 2.

FIG. 3B is a diagram for describing an example of information representing personality of another user that has been digitized by the user information acquisition unit in FIG. 2.

FIG. 4 is a diagram showing an example of a comparison result of profile information by a profile comparison unit in FIG. 2.

FIG. 5 is a diagram showing an example of a comparison result of entire profile information by the profile comparison unit in FIG. 2.

FIG. 6 is a flowchart showing an example of a process performed by the service providing apparatus according to the embodiment of the present invention.

### DESCRIPTION OF EMBODIMENT

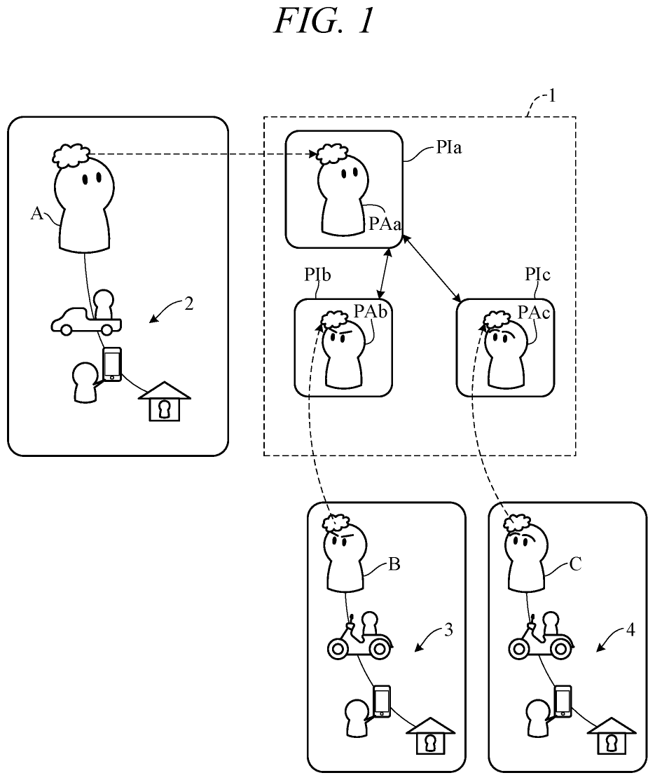

Hereinafter, embodiments of the present invention will be described with reference to FIGS. 1 to 6. A service providing apparatus according to an embodiment of the present invention automatically determines a service provider having the same sense of values from a plurality of service providers capable of providing a service to a user who requests the service.

FIG. 1 is a diagram schematically showing an application example of a service providing apparatus 1 according to an embodiment of the present invention. In FIG. 1, a user (a client) A who requests a service and users (service providers) B and C who provide the service are shown. The users A to C live their daily lives using user devices 2 to 4 including a vehicle, a smart phone, household electric appliances, and the like each having a communication function. The service providing apparatus 1 acquires respectively from the user devices 2 to 4 user information such as personal information that has been input by the users A to C, action histories, action schedules, and use states of the user devices 2 to 4. The service providing apparatus 1 stores profile information PIa to PIc including information representing the respective personalities of the users A to C based on information that has been acquired from the user devices 2 to 4, information of evaluations of the users A to C from other users, and the like. The profile information PIa to PIc stored in the service providing apparatus 1 is displayed on the user devices 2 to 4 as avatars PAa to PAc respectively having personalities of the users A to C, so as to function as agents for receiving instructions from the users A to C or providing information.

In a case where there are a plurality of service providers capable of providing the requested service, by the way, the satisfaction of both users is enhanced by determining the service provider so that the user who requests the service and the user who provides the service have the same sense of values. For example, when a service client who requests a service, such as a motorcycle delivery service, and meets a service provider who comes to collect cargo, the service client is able to request a service feeling at ease from a user who has similarities in personalities such as sociability, consideration, and the like, and who has the same sense of values. In addition, also for a service provider of a sharing service such as car sharing, the service provider is able to provide the service feeling at ease for a user who has similar personalities to the service provider, such as cleanliness.

However, in a case where the personal information or the like relating to the users A to C who requests or provides the service is presented to the other users A to C and determination of whether the sense of values is the same is entrusted to the users themselves, it is complicated and inconvenient for the users to whom the determination is entrusted, and in addition, it is not desirable from the viewpoint of privacy. Therefore, the service providing apparatus 1 according to an embodiment of the present invention is configured as follows, so as to determine a service provider, based on information representing personalities of the users A to C included in profile information PIa to PIc, that is, a similarity degree in the personalities of the avatars PAa to PAc.

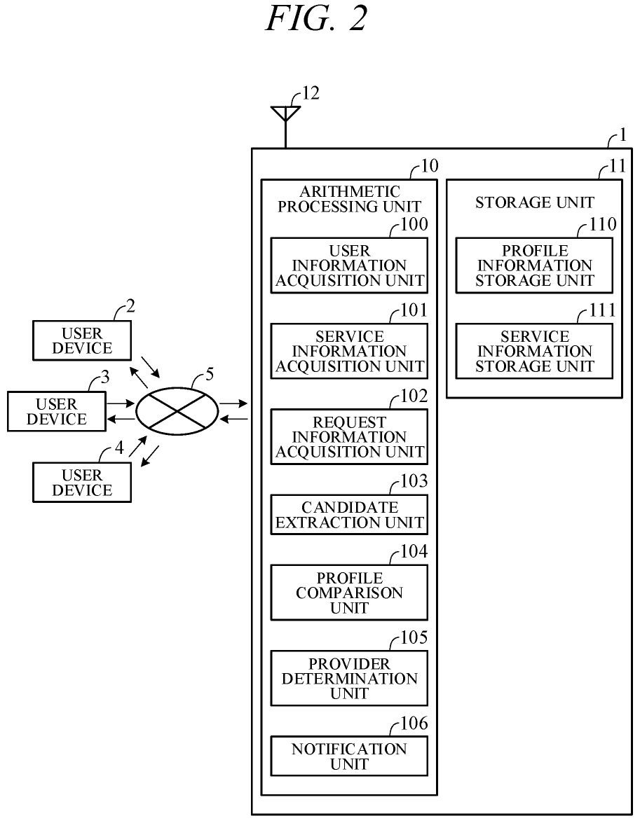

FIG. 2 is a block diagram schematically showing an example of a configuration of the service providing apparatus 1 according to an embodiment of the present invention. The service providing apparatus 1 is configured to be, for example, a computer such as a server, and is connected with a network 5 including public wireless communication networks represented by the Internet and mobile telephone networks. The service providing apparatus 1 and the user devices 2 to 4 are capable of communicating with each other through the network 5. It is to be noted that the network 5 includes a closed communication network provided for every predetermined management area, for example, a wireless LAN, Wi-Fi (registered trademark), Bluetooth (registered trademark), and the like.

The user devices 2 to 4 each include, for example, an input unit such as a touch panel operable by the users A to C and a microphone capable of inputting an audio instruction, a camera for acquiring images and voices, a location sensor for acquiring location information, and various sensors such as a vital sensor for acquiring biological information. The user devices 2 to 4 each transmit information such as a date of birth, an occupation, a schedule, and contributions to social network services (SNS) that have been input by the users A to C, and user information such as images and voices of the users, location information, and biological information of the users that have been acquired by the various sensors, to the service providing apparatus 1 through the network 5. The user information to be transmitted from each user device 2 to 4 is attached with identification information (for example, a user ID) of each user A to C.

The user information that has been acquired by the user devices 2 to 4 is transmitted to the service providing apparatus 1, as digital data on which the respective personalities of the users A to C are reflected. For example, the user information that has been acquired by the user devices 2 to 4, which are vehicles or the like, includes information about average vehicle speeds, frequencies of acceleration and deceleration, frequencies of giving way to others, and the like. The user information to be acquired by the user devices 2 to 4 for using mail and SNS includes information about confirmation frequencies of messages, quickness in response to others, and the like. The user information to be acquired by the user devices 2 to 4 for viewing contents such as moving images includes information about favorite genres and the like. The user information to be acquired by the user devices 2 to 4, which are respectively equipped with the location sensors and which are carried by the users, includes information about action histories of the users. The user information to be acquired by the user devices 2 to 4, which are smart speakers equipped with artificial intelligence (AI), includes information about contents and tones of voice inputs by the users. The user information to be acquired by the user devices 2 to 4, which are respectively wearable terminals equipped with vital sensors, includes information about changes in feeling of the users and the like.

Further, the user device 2 of the user A transmits information about a service requested by the user A (request information) to the service providing apparatus 1 through the input unit, whereas the user devices 3 and 4 of the users B and C transmit information about the services respectively provided by the users B and C (service information) to the service providing apparatus 1 through the input units. When the service providing apparatus 1 determines a service provider (the user B or C) for providing the service to the user A, the service providing apparatus 1 gives notification to the user devices 2 to 4. In addition, when the user A who has received the service carries out an evaluation of the user B or C, which has provided the service, the user device 2 of the user A transmits evaluation information to the service providing apparatus 1 via the input unit. In a similar manner, when the user B or C, who has provided a sharing service such as car sharing, carries out an evaluation of the user A, who has received the sharing service, the user device 3 or 4 of the user B or C transmits evaluation information to the service providing apparatus 1 via the input unit.

As shown in FIG. 2, the service providing apparatus 1 includes a computer including an arithmetic processing unit 10 such as a CPU for performing various processes, a storage unit 11 such as a ROM, a RAM, and a hard disk, and other peripheral circuits, not shown, and is communicable with the user devices 2 to 4 via a communication unit 12. The arithmetic processing unit 10 includes, as a functional configuration, a user information acquisition unit 100, a service information acquisition unit 101, a request information acquisition unit 102, a candidate extraction unit 103, a profile comparison unit 104, a provider determination unit 105, and a notification unit 106. The storage unit 11 has, as a functional configuration, a profile information storage unit 110 and a service information storage unit 111.

The user information acquisition unit 100 acquires user information that has been transmitted from the user devices 2 to 4. The user information that has been acquired by the user information acquisition unit 100 is stored in the profile information storage unit 110, as the profile information PIa to PIc of the respective users A to C. In addition, the user information acquisition unit 100 digitizes the respective personalities of the users A to C, based on the user information stored in the profile information storage unit 110. Information respectively representing the personalities of the users A to C that have been digitized by the user information acquisition unit 100 is stored as the profile information PIa to PIc in the profile information storage unit 110.

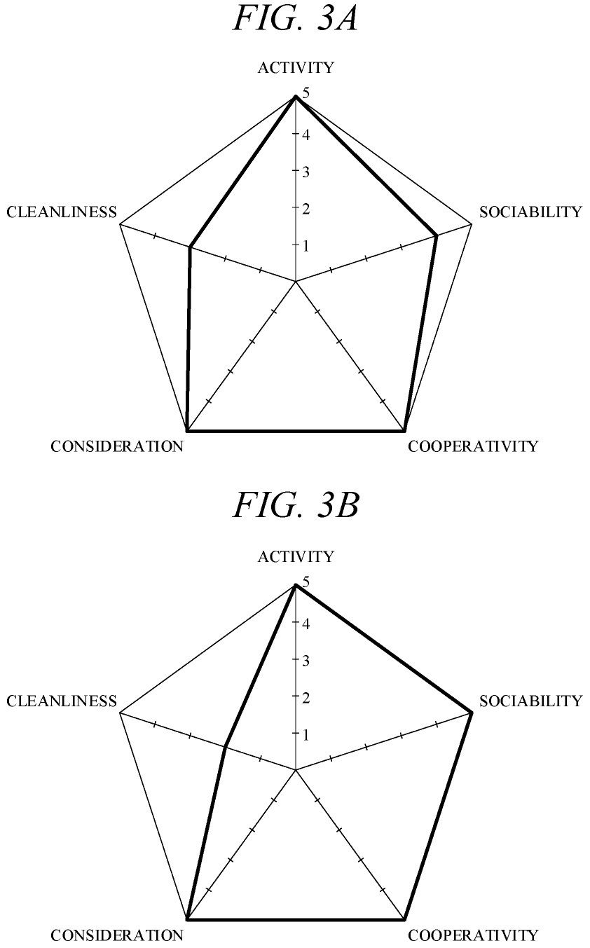

FIGS. 3A and 3B are diagrams for describing an example of the information representing the personalities of the users A and B that have been digitized by the user information acquisition unit 100. As shown in FIGS. 3A and 3B, the user information acquisition unit 100 digitizes the respective personalities of the users (A and B in the drawings) for respective parameters in various personality analysis methods for activity, sociability, cooperativity, consideration, cleanliness, and the like, based on the user information stored in the profile information storage unit 110. For example, as shown in FIG. 3A, the personality of user A is digitized to be high in the degrees of activity, cooperativity, and consideration (degrees=5), a slightly high in the degree of sociability (degree=4), and normal in the degree of cleanliness (degree=3). As shown in FIG. 3B, the personality of the user B is digitized to be high in the degrees of activity, sociability, cooperativity, and consideration (degrees=5) and a slightly low in the degree of cleanliness (degree=2).

The user information acquisition unit 100 periodically updates information representing the respective personalities of the users A to C, for example, every time acquiring new user information. Consequently, the personalities of the avatars PAa to PAc (FIG. 1) respectively become similar to those of the users A to C, or respectively change according to changes in the personalities of the users A to C. That is, the avatars PAa to PAc respectively having the personalities of the users A to C are grown up.

Further, the user information acquisition unit 100 acquires evaluation information of the users A to C that has been evaluated by other users, and calculates evaluation ranks of the respective users A to C, as average values, for example. The evaluation ranks that have been calculated by the user information acquisition unit 100 are also stored in the profile information storage unit 110, as the profile information PIa to PIc of the respective users A to C.

The service information acquisition unit 101 acquires the service information that has been respectively transmitted from the user devices 3 and 4 of the users B and C for providing services. The service information that has been acquired by the service information acquisition unit 101 is stored in the service information storage unit 111, as service information of the respective users B and C. For example, in a case where the users B and C provide motorcycle delivery services, the service information includes information of services to be provided (motorcycle services), location information (current locations and available areas), moving speeds, types and sizes of deliverable packages, available time zones, and the like. For example, in a case where the users B and C provide car sharing services, the service information includes information of the services to be provided (car sharing), location information (location information of garages), dates and times when the car sharing is available, vehicle types, and evaluation ranks demanded for clients, and the like.

The request information acquisition unit 102 acquires request information that has been transmitted from the user device 2 of the user A, who requests a service. For example, in a case where the user A requests a motorcycle delivery service, the request information includes information of a requested service (a motorcycle delivery), the type and size of a package, a collection destination and a delivery destination, desired dates and times of collection and delivery, and the like. In addition, for example, in a case where the user A requests a car sharing service, the request information includes information of a requested service (car sharing), a desired area, a date and a time, a vehicle type, an evaluation rank demanded for a service provider.

The candidate extraction unit 103 extracts the users B and C as service provider candidates capable of providing the service that has been requested by the user A, based on request information of the service that has been requested by the user A and that has been acquired from the request information acquisition unit 102, the service information of the respective users B and C stored in the service information storage unit 111, and the evaluation ranks that have been calculated by the user information acquisition unit 100.

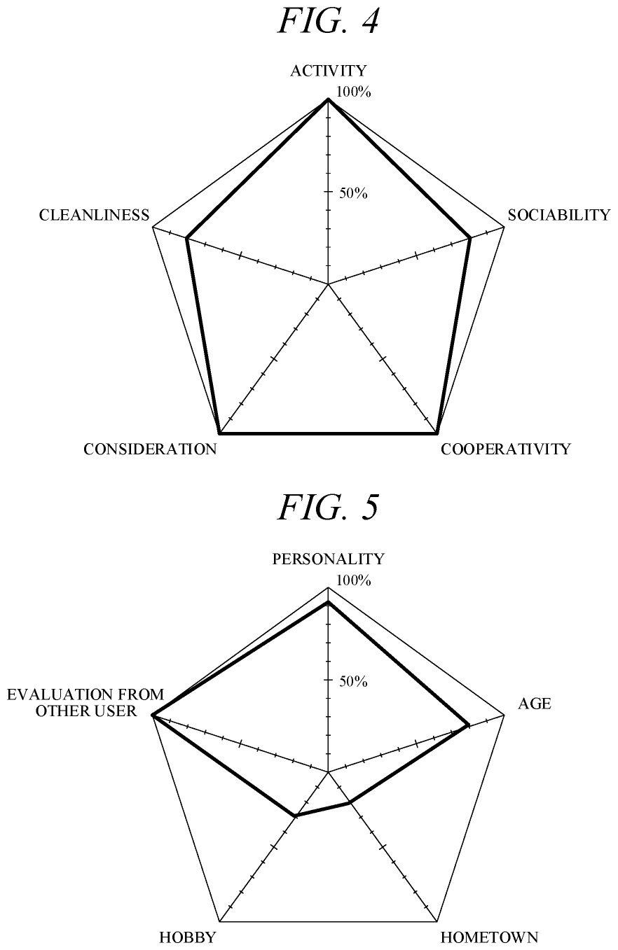

The profile comparison unit 104 calculates a similarity degree SOC between the personality of the user A who has requested the service that have been acquired from the user information acquisition unit 100 and that have been digitized, and the personalities of the users B and C that have been extracted as the service provider candidates by the candidate extraction unit 103. FIG. 4 is a diagram showing an example of a comparison result of the profile information PIa to PIc by the profile comparison unit 104, and shows a comparison result of the personalities of the users A and B shown in FIGS. 3A and 3B. For example, the profile comparison unit 104 calculates similarity degrees in the respective parameters to be 100% in a case where the degrees in the respective parameters of the personalities of the users A and B match each other and to be 80% in a case where the degree difference is 1, and then calculates an average value of the similarity degrees in the respective parameters as the similarity degree SOC in the personalities. In a case where the personalities of the users A and B shown in FIGS. 3A and 3B are compared with each other, as shown in FIG. 4, the profile comparison unit 104 calculates to be 100% in the similarity degrees in action, cooperativity, and consideration, calculates to be 80% in the similarity degrees in sociability and cleanliness, and calculates to be 92% in the similarity degree SOC in personalities. Weighting may be set for each parameter to be emphasized in accordance with a service content.

In addition, the profile comparison unit 104 calculates a similarity degree SOP in the entire profile information PIa to PIc including the respective personalities of the user A who has requested the service and the users B and C who have been extracted as the service provider candidates by the candidate extraction unit 103. FIG. 5 is a diagram showing an example of a comparison result of the entire profile information PIa to PIc by the profile comparison unit 104, and shows a comparison result of the entire profile information PIa to PIc between the user A and the user B. The profile information PIa to PIc includes information representing backgrounds of the users A to C, such as age, hometown, family structure, and hobby, in addition to the information representing the personalities of the users A to C. As the similarity degree in the information representing such backgrounds is higher, the possibility that the users' senses of values match each other becomes higher.

The profile comparison unit 104 calculates the similarity degrees in the respective parameters in a suitable method, for example to be 100% in a case where the ages are the same, to be 80% in a case where the age difference is within five years, to be 100% in a case where the hometown is the same, and to be 80% in a case of being in the same area, and calculates the average value of the similarity degrees in the respective parameters as the similarity degree SOP in the entire profile information PIa to PIc. For example, as shown in FIG. 5, the profile comparison unit 104 calculates the similarity degree SOC in personality between the users A and B to be 92%, the similarity degree in age to be 80%, the similarity degree in hometown to be 20%, the similarity degree in family structure to be 30%, and the similarity degree in hobby to be 100%, and the similarity degree SOP in the entire profile information PIa and PIb to be 64.4%. Weighting may be set for each parameter to be emphasized in accordance with a service content.

The provider determination unit 105 determines a service provider for providing a service to the user A, who requests the service, based on the similarity degree SOP in the entire profile information PIa to PIc that has been calculated by the profile comparison unit 104. For example, the provider determination unit 105 determines the user B or C having the highest similarity degree SOP in the entire profile information PIa to PIc, as the service provider. In a case where the user A who requests the service desires to receive the service from a user having the same sense of values, and there is no user having the similarity degree SOP in the entire profile information PIa to PIc equal to or higher than a predetermined value, the provider determination unit 105 may determine that there is no user who is able to provide the service. In a case where there are a plurality of users having the same similarity degree SOP in the entire profile information PIa to PIc, the provider determination unit 105 determines one of the users as a most suitable service provider for providing the service to the user A, based on the location information of the users A to C. Accordingly, the moving efficiency in providing the service is enhanced.

The notification unit 106 gives notification of the information about the user (for example, the user B) who has been determined as the service provider by the provider determination unit 105 to the user A who requests the service, and also gives notification of the information about the user A who requests the service to the user B who has been determined as the service provider. In a case where the user A who requests the service desires to receive the service from a user having the same sense of values, the notification unit 106 may give notification when a user having the similarity degree SOP in the entire profile information PIa to PIc, which is equal to or higher than a predetermined value, becomes able to provide the service. The information notified by the notification unit 106 includes minimum information only necessary for providing the service, such as a name and contact information of each user.

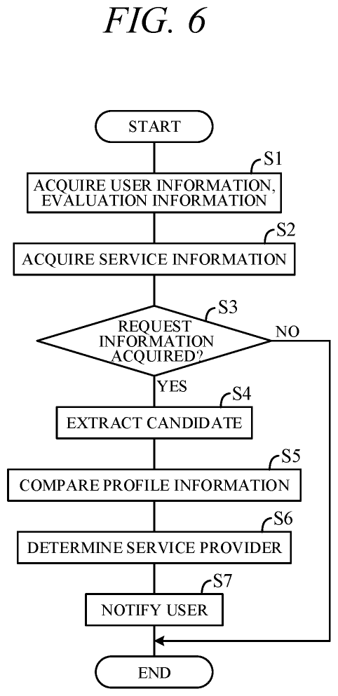

FIG. 6 is a flowchart showing an example of a process performed by the arithmetic processing unit 10 of the service providing apparatus 1, according to a program stored beforehand. The process shown in this flowchart is started, for example, when the power supply of the service providing apparatus 1 is turned on, and is repeated at a predetermined cycle.

First, in step S1, the user information acquisition unit 100 performs a process of acquiring the user information of the users A to C that have been transmitted from the user devices 2 to 4 and the evaluation information about the users A to C evaluated from other users, digitizing the respective personalities of the users A to C, calculating the evaluation ranks, and storing the evaluation ranks as profile information PIa to PIc in the profile information storage unit 110. Next, in step S2, the service information acquisition unit 101 performs a process of acquiring the service information of the users B and C that have been respectively transmitted from the user devices 3 and 4, and storing the service information in the service information storage unit 111. Next, in step S3, the request information acquisition unit 102 performs a process of determining whether the request information has been acquired from the user device 2. In a case where the determination is positive in step S3, the process proceeds to step S4, and in a case where the determination is negative, the process ends.

In step S4, the candidate extraction unit 103 performs a process of extracting service provider candidates (for example, the users B and C), based on the evaluation ranks calculated in step S1, the service information acquired in steps S2 and S3, and the request information. Next, in step S5, the profile comparison unit 104 performs a process of comparing the profile information PIa of the client (the user A) with the profile information PIb and PIC of the respective service provider candidates (the users B and C). Next, in step S6, the provider determination unit 105 performs a process of determining a service provider (for example, the user B), based on the comparison result in step S5. Next, in step S7, the notification unit 106 performs a process of transmitting the information about the client (the user A) and the service provider (the user B) determined in step S6 to the user devices 2 and 3.

The main operation of the service providing apparatus 1 according to the present embodiment will be described more specifically. The service providing apparatus 1 acquires user information and evaluation information about the users A to C that has been transmitted from the user devices 2 to 4, which are used by the users A to C to live their daily lives, grows up the avatars PAa to PAc having the respective personalities of the users A to C, and applies the evaluation ranks (Step S1). Accordingly, the users A to C are able to utilize the avatars PAa to PAc having the same personalities as their own and understanding their own preferences, as agents in using the user devices 2 to 4 without making special settings for the respective user devices 2 to 4. For example, in a case where the user devices 2 to 4 are respectively vehicle navigation devices, routes on which preferences are reflected can be set, music according to the preferences can be played in a case of a smart speaker, and information in accordance with a living time zone can be provided.

Upon acquisition of the request information from the service client (the user A), the service providing apparatus 1 extracts service provider candidates capable of providing the service, based on the service information from the service providers (the users B and C) and the evaluation rank information of the users A to C (Steps S2 to S4). Further, the service providing apparatus 1 determines a service provider for providing the service to the client, based on the profile information PIa to PIc of the users A to C, and gives notification to the service provider that has been determined and the service client (Steps S5 to S7). The users having the same senses of values are automatically matched, based on the profile information PIa to PIc of the users A to C. This configuration eliminates the need for referring to information about the other sides or making a choice by the service client or the service provider for providing the sharing service by themselves. In addition, the user information or the evaluation information of the users A to C is not provided to other users, so that the privacy of the users A to C is protected. In providing a service, by matching the users who have the same senses of values, the satisfaction of both users on a service provider side and on a service client side can be improved beyond a scope such as training for the service provider and an agreement for the service client.

The present embodiment can achieve advantages and effects such as the following:

(1) The service providing apparatus 1 includes: the profile information storage unit 110 configured to store the plurality of profile information PIa to PIc including information representing personality of each of the plurality of service provider (user B, C) providing service and the user (user A); the service information storage unit 111 configured to store the service information about the plurality of service provider and the service provided by the plurality of service provider; the request information acquisition unit 102 configured to acquire the request information about the service requested by the user; the candidate extraction unit 103 configured to extract the service provider candidate who can provide the service requested by the user to the user from among the plurality of service provider stored in the service information storage unit 111 based on the request information acquired by the request information acquisition unit 102; the profile comparison unit 104 configured to compare the plurality of profile information PIa to PIc about the candidate extracted by the candidate extraction unit 103 and the user stored in the profile information storage unit 110; the provider determination unit 105 configured to determine the service provider who provides the service requested by the user to the user based on the comparison result by the profile comparison unit 104; and the notification unit 106 configured to notify the service provider determined by the provider determination unit 105 and the user of information about the service provider determined by the provider determination unit 105 (FIG. 2). Accordingly, the service provider who has the same sense of values to the service client can be automatically determined, based on the profile information PIa to PIc of the users A to C.

(2) The profile comparison unit 104 calculates the similarity degree SOC between personality of the candidate extracted by the candidate extraction unit 103 and personality of the user based on the plurality of profile information PIa to PIc stored in the profile information storage unit 110. The provider determination unit 105 determines the service provider who provides the service requested by the user to the user based on the similarity degree SOC calculated by the profile comparison unit 104. Accordingly, the users having similar personalities and the same senses of values are matched, the client is able to request a service feeling at ease, and the service provider is able to provide the sharing service feeling at ease.

(3) The service providing apparatus 1 further includes: the user information acquisition unit 100 configured to acquire the user information of each of the plurality of service provider and the user transmitted from the user devices 2 to 4 of each of the plurality of service provider and the user and configured to store the user information acquired in the profile information storage unit 110 as the plurality of profile information PIa to PIc; and the service information acquisition unit 101 configured to acquire the service information about the service provided by the plurality of service provider transmitted from the user devices 3, 4 of the plurality of service provider and configured to store the service information acquired in the service information storage unit 111 (FIG. 2). Accordingly, the avatars PAa to PAc respectively having personalities of the users A to C, who are the service client and the service providers, are automatically grown up.

(4) The user information acquisition unit 100 digitizes personality of each of the plurality of service provider and the user based on the plurality of profile information PIa to PIc stored in the profile information storage unit 110. Accordingly, the similarity degree SOC in the personalities of the users A to C (the avatars PAa to PAc) can be calculated, based on the digitized personalities of the users A to C, who are the service providers and the service client.

(5) The user information acquisition unit 100 further acquires the location information of each of the plurality of service provider and the user. The candidate extraction unit 103 extracts the candidate who can provide the service requested by the user to the user from among the plurality of service provider based on the location information acquired by the user information acquisition unit 100. Accordingly, the moving efficiency in providing the service is enhanced.

The above embodiment can be modified in various manners. Hereinafter, modified examples will be described. In the embodiment described above, the provider determination unit 105 determines, as the service provider, a user having a high similarity degree SOC in personality with the user A who requests the service and having a high similarity degree SOP in the entire profile information PIa to PIc, based on the comparison result by the profile comparison unit 104. However, the provider determination unit, which determines the service provider for providing the service, based on a comparison result by the profile comparison unit, is not limited to the one described above. For example, users who are suited well with each other, such as a user who likes to rely on others and a user who likes to be relied on from others, may be matched.

In the embodiment described above, in a case where the user A who requests a service desires to receive the service from a user having the same sense of values, the notification unit 106 gives notification when the user having the similarity degree SOP in the entire profile information PIa to PIc is equal to or higher than a predetermined value. However, the notification unit, which gives notification of the information about the service provider that has been determined by the provider determination unit to the service provider that has been determined and the client, is not limited to the one described above. For example, only the information about the service provider and the client is transmitted to the user devices 2 to 4 of the service provider that has been determined and the client, and detailed matters such as a schedule for providing the service may be adjusted between the avatars PAa to PAc serving as agents for managing the schedules of the users.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 service providing apparatus, 2 to 4 user device, 5 network, 10 arithmetic processing unit, 11 storage unit, 12 communication unit, 100 user information acquisition unit, 101 service information acquisition unit, 102 request information acquisition unit, 103 candidate extraction unit, 104 profile comparison unit, 105 provider determination unit, 106 notification unit, 110 profile information storage unit, 111 service information storage unit.

1. A service providing apparatus, comprising:
a processor and a memory coupled to the processor, wherein
the memory is configured to function as:
a profile information storage unit configured to store a plurality of profile information including information representing personality of each of a plurality of service provider providing service and a user; and
a service information storage unit configured to store service information about the plurality of service provider and the service provided by the plurality of service provider, wherein
the processor is configured to function as:
a request information acquisition unit configured to acquire request information about a service requested by the user;
a candidate extraction unit configured to extract a candidate who can provide the service requested by the user to the user from among the plurality of service provider stored in the service information storage unit based on the request information acquired by the request information acquisition unit;
a profile comparison unit configured to compare the plurality of profile information about the candidate extracted by the candidate extraction unit and the user stored in the profile information storage unit;
a provider determination unit configured to determine a service provider who provides the service requested by the user to the user based on a comparison result by the profile comparison unit; and
a user information acquisition unit configured to acquire user information of each of the plurality of service provider and the user transmitted from a user device of each of the plurality of service provider and the user and configured to store the user information acquired in the profile information storage unit as the plurality of profile information, wherein
the user information acquisition unit acquires the user information of each of the plurality of service provider and the user based on a use state of the user device of each of the plurality of service provider and the user.

2. The service providing apparatus according to claim 1, wherein
the profile comparison unit calculates a similarity degree between personality of the candidate extracted by the candidate extraction unit and personality of the user based on the plurality of profile information stored in the profile information storage unit, wherein
the provider determination unit determines the service provider who provides the service requested by the user to the user based on the similarity degree calculated by the profile comparison unit.

3. The service providing apparatus according to claim 1, wherein
the processor is configured to function as:
a service information acquisition unit configured to acquire service information about the service provided by the plurality of service provider transmitted from the user device of the plurality of service provider and configured to store the service information acquired in the service information storage unit.

4. The service providing apparatus according to claim 1, wherein
the user information acquisition unit digitizes personality of each of the plurality of service provider and the user based on the plurality of profile information stored in the profile information storage unit.

5. The service providing apparatus according to claim 1, wherein
the user information acquisition unit further acquires location information of each of the plurality of service provider and the user, wherein
the candidate extraction unit extracts the candidate who can provide the service requested by the user to the user from among the plurality of service provider stored in the service information storage unit further based on the location information acquired by the user information acquisition unit.

6. A service providing apparatus, comprising:
a processor and a memory coupled to the processor, wherein
the memory is configured to function as:
a profile information storage unit configured to store a plurality of profile information including information representing personality of each of a plurality of service provider providing service and a user; and
a service information storage unit configured to store service information about the plurality of service provider and the service provided by the plurality of service provider, wherein
the processor is configured to function as:
a request information acquisition unit configured to acquire request information about a service requested by the user;
a candidate extraction unit configured to extract a candidate who can provide the service requested by the user to the user from among the plurality of service provider stored in the service information storage unit based on the request information acquired by the request information acquisition unit;
a profile comparison unit configured to compare the plurality of profile information about the candidate extracted by the candidate extraction unit and the user stored in the profile information storage unit;
a provider determination unit configured to determine a service provider who provides the service requested by the user to the user based on a comparison result by the profile comparison unit; and
a user information acquisition unit configured to acquire user information of each of the plurality of service provider and the user transmitted from a user device of each of the plurality of service provider and the user and configured to store the user information acquired in the profile information storage unit as the plurality of profile information, wherein
the profile comparison unit sets weighting for parameters constituting personality of each of the plurality of service provider and the user based on the request information acquired by the request information acquisition unit and calculates similarity degree between personality of the candidate extracted by the candidate extraction unit and personality of the user for each of the parameters based on the plurality of profile information stored in the profile information storage unit.

7. A service providing apparatus, comprising:
a processor and a memory coupled to the processor, wherein
the memory is configured to perform:
storing a plurality of profile information including information representing personality of each of a plurality of service provider providing service and a user; and
storing service information about the plurality of service provider and the service provided by the plurality of service provider, wherein the processor is configured to perform:
acquiring request information about a service requested by the user;
extracting a candidate who can provide the service requested by the user to the user from among the plurality of service provider stored in the memory based on the request information acquired;
comparing the plurality of profile information about the candidate extracted and the user stored in the memory;
determining a service provider who provides the service requested by the user to the user based on the comparison result;
acquiring user information of each of the plurality of service provider and the user transmitted from a user device of each of the plurality of service provider and the user; and
storing the user information acquired in the memory as the plurality of profile information, wherein
the processor is configured to perform:
the user information acquiring including acquiring the user information of each of the plurality of service provider and the user based on a use state of the user device of each of the plurality of service provider and the user.

8. The service providing apparatus according to claim 7, wherein
the processor is configured to perform:
the comparing including calculating a similarity degree between personality of the candidate extracted and personality of the user based on the plurality of profile information stored in the memory; and
the determining including determining the service provider who provides the service requested by the user to the user based on the similarity degree calculated.

9. The service providing apparatus according to claim 7, wherein
the processor is configured to perform:
acquiring service information about the service provided by the plurality of service provider transmitted from the user device of the plurality of service provider; and
storing the service information acquired in the memory.

10. The service providing apparatus according to claim 7, wherein
the processor is configured to perform:
the user information acquiring including digitizing personality of each of the plurality of service provider and the user based on the plurality of profile information stored in the memory.

11. The service providing apparatus according to claim 7, wherein
the processor is configured to perform:
the user information acquiring including further acquiring location information of each of the plurality of service provider and the user; and
the extracting including extracting the candidate who can provide the service requested by the user to the user from among the plurality of service provider stored in the memory further based on the location information acquired.

12. A service providing apparatus, comprising:
a processor and a memory coupled to the processor, wherein
the memory is configured to perform:
storing a plurality of profile information including information representing personality of each of a plurality of service provider providing service and a user; and
storing service information about the plurality of service provider and the service provided by the plurality of service provider, wherein the processor is configured to perform:
acquiring request information about a service requested by the user;
extracting a candidate who can provide the service requested by the user to the user from among the plurality of service provider stored in the memory based on the request information acquired;
comparing the plurality of profile information about the candidate extracted and the user stored in the memory;
determining a service provider who provides the service requested by the user to the user based on the comparison result;
acquiring user information of each of the plurality of service provider and the user transmitted from a user device of each of the plurality of service provider and the user; and
storing the user information acquired in the memory as the plurality of profile information, wherein
the processor is configured to perform:
the comparing including:
setting weighting for parameters constituting personality of each of the plurality of service provider and the user based on the request information acquired; and
calculating similarity degree between personality of the candidate extracted and personality of the user for each of the parameters based on the plurality of profile information stored in the memory.
